(19) United States
(12) Patent Application Publication
(10) Pub. No.: US 2008/0211690 A1
(43) Pub. Date: Sep. 4, 2008

(54) E-FIELD/B-FIELD/ACOUSTIC GROUND TARGET DATA FUSED MULTISENSOR METHOD AND APPARATUS

(76) Inventors: Robert Theodore Kinasewitz, New York, NY (US); Leon Edward Owens, Budd Lake, NJ (US)

Correspondence Address: U.S. ARMY TACOM-ARDEC;ATTN: AMSTRA-AR-GCL, BLDG 3, PICATINNY ARSENAL, NJ, 07806-5000, US

(21) Appl. No.: 11/306,599

(22) Filed: Jan. 4, 2006

Related U.S. Application Data
(60) Provisional application No. 60/593,283, filed on Jan. 4, 2005.
(60) Provisional application No. 60/594,795, filed on May 6, 2005.

(51) Int. Cl. G08G 1/01

(52) U.S. Cl. 340/933

(57) ABSTRACT

A set of sensors and accompanying method(s) that permit the rapid and reliable determination of the type of object sensed within a surveillance area thereby allowing accurate, real-time threat assessment and associated action(s). The set of sensors (or multisensor) deployed with the surveillance area may include E-Field sensors, B-Field sensors and Acoustic sensors that provide sensor specific characteristics of an object which—when processed according to our data fusion method(s)—produces higher order information such as the ability to accurately differentiate between humans, humans not carrying magnetic materials, humans carrying magnetic materials (such as firearms), and vehicles—both armored and unarmored.

### CROSS-REFERENCE TO RELATED APPLICATIONS

This application claims the benefit under 35 USC 119(e) of U.S. Provisional Patent Application No. 60/593,283, filed Jan. 4, 2005, and U.S. Provisional Patent Application No. 60/594,795, filed May 6, 2005, the entire file wrapper contents of which provisional applications are herein incorporated by reference as though set forth at length.

### FEDERAL INTEREST STATEMENT

The inventions described herein may be manufactured, used and licensed by or for the U.S. Government for U.S. Government purposes without payment of any royalties thereon or therefore.

### BACKGROUND OF INVENTION

1. Field of the Invention

This invention relates generally to the surveillance of one or more objects over a surveillance area. More particularly, it relates to methods and apparatus for the determination of specific types of objects within the surveillance area—i.e., person(s), threatening person(s), and/or vehicles, while facilitating the fusion of such object specific data into more useful or otherwise actionable information.

2. Background of the Invention

Multi-sensor surveillance systems and methods are receiving significant attention for both military and non-military applications due, in part, to a number of operational benefits provided by such systems and methods. In particular, some of the benefits provided by multi-sensor systems include: Robust operational performance is provided because any one particular sensor of the multi-sensor system has the potential to contribute information while others are unavailable, denied (jammed), or lacking coverage of an event or target; Extended spatial coverage is provided because one sensor can “look” where another sensor cannot; Extended temporal coverage is provided because one sensor can detect or measure at times that others cannot; Increased confidence is accrued when multiple independent measurements are made on the same event or target; Reduced ambiguity in measured information is achieved when the information provided by multiple sensors reduces the set of hypothesis about a target or event; Improved detection performance results from the effective integration of multiple, separate measurements of the same event or target; Increased system operational reliability may result from the inherent redundancy of a multi-sensor suite; and Increased dimensionality of a measurement space (i.e., different sensors measuring various portions of the electro-magnetic spectrum) reduces vulnerability to denial (countermeasures, jamming, weather, noise) of any single portion of the measurement space.

These benefits however, do not come without a price. The overwhelming volume and complexity of the disparate data and information produced by multi-sensor systems is well beyond the ability of humans to process, analyze and render decisions in a reasonable amount of time. Consequently, data fusion technologies are being developed to help combine various data and information structures into form(s) that are more convenient and useful to human operators.

Briefly stated, data fusion involves the acquisition, filtering, correlation and integration of relevant data and/or information from various sources, such as multi-sensor surveillance systems, databases, or knowledge bases into one or more formats appropriate for deriving decisions, system goals (i.e., recognition, tracking, or situation assessment), sensor management or system control. The objective of data fusion is the maximization of useful information, such that the fused information provides a more detailed representation with less uncertainty than that obtained from individual source(s). While producing more valuable information, the fusion process may also allow for a more efficient representation of the data and may further permit the observation of higher-order relationships between respective data entities.

A long-standing need has existed for simple, accurate, and relatively inexpensive sensor(s) and associated techniques that could detect and differentiate between different types of objects passing through a surveillance area. Of particular importance, is the ability to differentiate between threatening and non-threatening objects (i.e., persons with weapons vs. persons without weapons; adults vs. children; and military vs. non-military vehicles).

Such a sensor system and accompanying method(s) would therefore represent a significant advance in the art.

### SUMMARY OF THE INVENTION

We have developed—in accordance with the teachings of the present invention—a set of sensors and accompanying method(s) that permit the rapid and reliable determination of the type of object encountered or otherwise sensed within a surveillance area. More specifically—and of particular importance to real-time battlefield decisions—it advantageously permits the determination of whether a sensed object represents a threat—or not.

Viewed from a first aspect, the present invention is directed to a set of sensors (multisensor) deployed within a surveillance area that may include, for example, an E-field sensor(s), B-field sensor(s), and Acoustic sensor(s) that detect sensor-specific characteristics of an object. Viewed from a second aspect, the present invention is directed to a data fusion method that integrates the data received from the separate, specific sensors into higher order information where specific object determinations may be made.

By way of example(s), our inventive sensors and accompanying data-fusion method(s) will detect and differentiate between humans, humans not carrying magnetic materials, humans carrying magnetic materials (such as firearms), and vehicles—both armored and unarmored.

### BRIEF DESCRIPTION OF THE DRAWING

Various features and advantages of the present invention and the manner of attaining them will be described in greater detail with reference to the following description, claims and drawing in which reference numerals are reused—where appropriate—to indicate a correspondence between the referenced items, and wherein:

FIG. 1 is a schematic illustration of an exemplary surveillance area including a number of sensors according to the present invention;

FIG. 2 is a schematic illustration of an exemplary surveillance system according to the present invention;

FIG. 3 is a flowchart illustrating our inventive data fusion method according to the present invention;

FIG. 3a is a continuation of the flowchart of FIG. 3 illustrating our inventive data fusion method employing acoustic sensors according to the present invention;

FIG. 4 is a graph showing E-Field measured perturbations for a person walking without a metal pipe;

FIG. 5 is a graph showing E-Field measured perturbations for a person walking with a metal pipe;

FIG. 6 is a graph showing E-Field measured perturbations for a vehicle (car) driving by a sensor; and

FIG. 7 is a block diagram showing a representative, highly integrated multisensor system according to the present invention.

### DETAILED DESCRIPTION OF THE PREFERRED EMBODIMENT

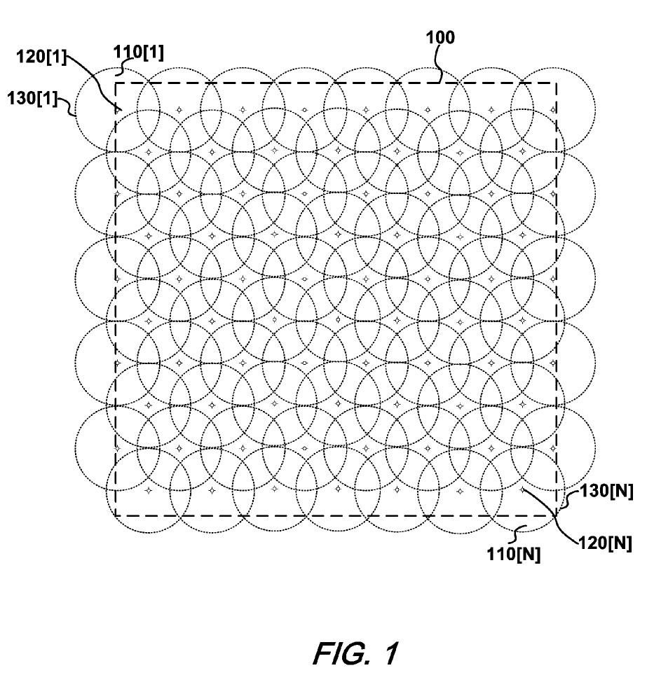

FIG. 1 is a schematic illustration of a surveillance area that will serve as a starting point for a discussion of the present invention. In particular, and with reference to that FIG. 1, there is shown a surveillance area 100 having a plurality of sensor systems 120[1] . . . 120[N] situated therein. Each of the individual sensor systems 120[1] . . . 120[N] monitors a respective sensory area 110[1] . . . 110[N], each individual area being defined by sensory perimeter 130[1] . . . 130[N], respectively.

With continued reference to FIG. 1, the sensory areas 110[1] . . . 110[N] are shown overlapping their respective adjacent sensory areas. While such an arrangement is not essential to the operation of a surveillance system or a surveillance system constructed according to the present invention, overlapping the sensory areas in this manner ensures that the entire surveillance area 100 is sensed by one or more individual sensor systems and that there are no “blind” areas within the surveillance area 100. Consequently, an object located anywhere within the surveillance area 100, that is the focus of a surveillance activity (not specifically shown in the FIG. 1, and hereinafter referred to as a “target”), may possibly be sensed by one or more of the sensor systems 120[1] . . . 120[N].

Advantageously, when multiple sensor systems are arranged in a manner like that shown in FIG. 1, even if a target moves within the surveillance area 100, it will be sensed by other subsequent sensor systems when that target is located within their respective sensory area(s). Additionally, when a target is sensed by multiple sensor systems—because it is situated within overlapped sensory areas of multiple sensor systems—the reliability of the sensed data may be improved as multiple, independent sensor systems provide their independent sensory data.

Importantly, while the FIG. 1 illustrates only a single sensor system (i.e., 120[1]) within a particular sensory area (i.e., 110[1]), it should be understood and appreciated by those skilled in the art that multiple sensor systems may occupy a single sensory area. Consequently, and according to one important aspect of the present invention—the multiple sensor systems need not even be responsive to the same sensory stimulus.

For example, a given sensory area could have sensor systems responsive to E-Field, B-Field (Magnetometers), acoustic, electromagnetic, vibrational, chemical, visual or non-visual stimulus, or a combination thereof. In this manner, a target that did not produce, for example, an audible signature may nevertheless produce a vibrational signature, capable of being detected by a vibrational sensor system. Still further—and according to the present invention—when dissimilar sensor systems or sets of sensor systems (i.e., E-Field, B-Field and/or Acoustic) detect a particular object—it becomes possible to determine more precisely what type of object is being detected.

In particular we have observed that quasi-static electricity generated by passing individuals and/or vehicles generate temporal perturbation(s) in the geoelectric field. These perturbations, while small, may be measured using small, highly sensitive E-Field sensors.

Of further importance, geoelectric field perturbations caused by persons (both with and without magnetic materials) and vehicles exhibit very different, detectable, and consequently recognizable differences in E-Field signatures. As a result, using B-Field sensors (magnetometers) in addition to the E-Field sensors mentioned, we have advantageously made simultaneous measurement of geomagnetic field perturbations due to persons both with and without magnetic materials passing within an effective area of our sensor(s). As can be readily appreciated by those skilled in the art, such a combined determination may serve as the basis for our inventive detection/determination sensor system.

At this point it is essential to note that while we have so far limited the discussion of our combined sensor systems to those only including E-Field and B-Field sensor(s), our invention is not so limited. More specifically, by including acoustic sensor(s) (and others) along with the E-Field and B-Field sensors, more flexible, and accurate determinations may be made.

As is known, acoustic sensors and accompanying algorithm(s) have been developed by the art to detect vehicles powered by internal combustion engines. Consequently, such acoustic sensors, when used in combination with the E-Field and B-Field sensors described, may comprise a comprehensive sensory system which—when combined with our inventive data fusion method(s)—can provide one with the ability to discriminate among various object types that are detected within a particular surveillance area.

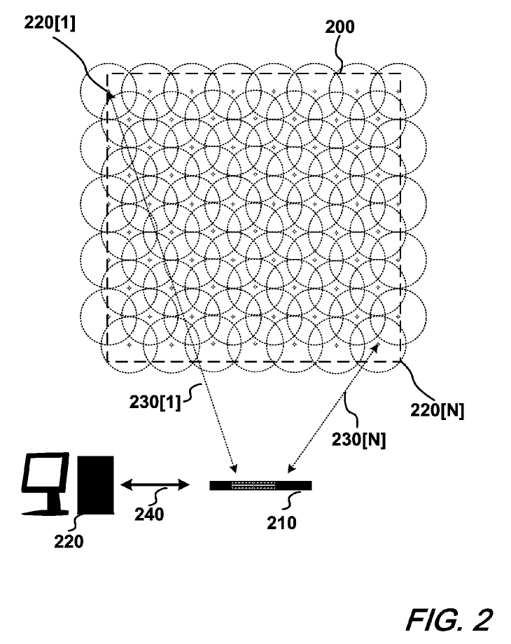

Turning our attention now to FIG. 2, there is shown a surveillance system according to the present invention. Specifically shown in FIG. 2, surveillance area 200 includes a plurality of sensor systems 220[1] . . . 220[N], which are shown arranged in a manner consistent with that shown in FIG. 1.

In this exemplary surveillance system, each of the individual sensor systems 220[1] . . . 220[N] is in communication with communications hub 210 via individual sensor communications links 230[1] . . . 230[N], respectively. It should be noted that for the sake of clarity, not all of the individual communications links are shown in the FIG. 2. Nevertheless, it is understood that one or more individual communications link(s) exist from an individual sensor system to the communications hub 210.

Further, such communications link(s) may be any one or a mix of known types. In particular, while surveillance systems such as those described herein are particularly well suited (or even best suited) to wireless communications link(s), a given surveillance application may be used in conjunction with wired, or optical communications link(s). Advantageously, the present invention is compatible with all such links.

Of course, surveillance applications generally require flexibility, distributed across a wide geography including various terrain(s) and topographies. As such, wireless methods are preferably used and receive the most benefits from the employment of the present invention. Of particular importance to these wireless systems, is the very high transmission compression rates afforded, thereby allowing the maximum amount of data transmitted in a minimal amount of time. Such benefit(s), as will become much more apparent to the reader, facilitate scalability as additional wireless sensor systems may be incrementally added to an existing surveillance area as requirements dictate, and because sensory systems do not have to transmit for extended periods of time, power consumption is reduced and delectability (by unfriendly entities) of the sensor systems themselves is reduced.

The communications hub 210 provides a convenient mechanism by which to receive data streams transmitted from each of the sensor systems situated within the surveillance area 200. As can be appreciated by those skilled in the art, since the surveillance area 200 may include hundreds or more sensor systems, the communications hub 210 must be capable of receiving data streams in real time from such a large number of sensor systems. In the situation where different types of communications links are used between communications hub 210 and individual sensor(s) systems, the hub 210 must accommodate the different type of communications link or additional hub(s) (not specifically shown) which do support the different communications link(s) may be used in conjunction with hub 210.

As depicted in the FIG. 2, the master communication link 240 provides a bi-directional communications path(s) between the master processing system 220 and the communications hub 210. Data received by the communications hub 210 via communications links 230[1] . . . 230[N] are communicated further to the master processing system 220 via the master communications link 240. Necessarily, the master communications link 240 in the downlink direction is of sufficient bandwidth to accommodate the aggregate traffic received by communications hub 210. Similarly, the uplink bandwidth of the master communications link 240—while typically much less than the downlink bandwidth—must support any uplink communications from the master processing system 220 to the plurality of sensor systems situated in the surveillance area 200.

According to the present invention, master processing system 220 receives data from one or more sensors 220[1] . . . 220[N] positioned within the surveillance area 200 and further processes the received data thereby deriving further informational value. As can be appreciated, the data contributed from multiple sensor systems with the surveillance area 200, is “fused” such that the further informational value may be determined. When this data fusion involves the E-Field, B-Field, Acoustic and/or other sensors described previously and our inventive method, the result is a determination of the specific type of object(s) detected within the surveillance area at a given time.

The master processing system 220 may offer equivalent functions of present-day, commercial computing systems. Consequently, the master processing system 220 exhibits the ability to be readily re-programmed, thereby facilitating the development of new data fusion methods/algorithms and/or expert systems to further exploit the enhanced data fusion potential of the present invention.

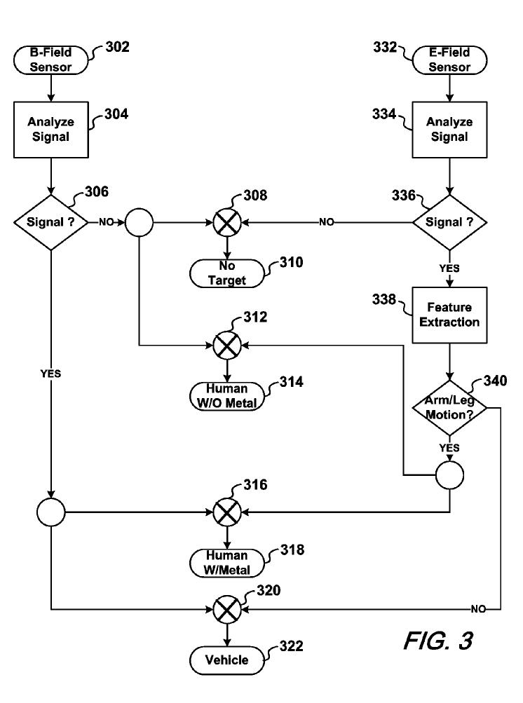

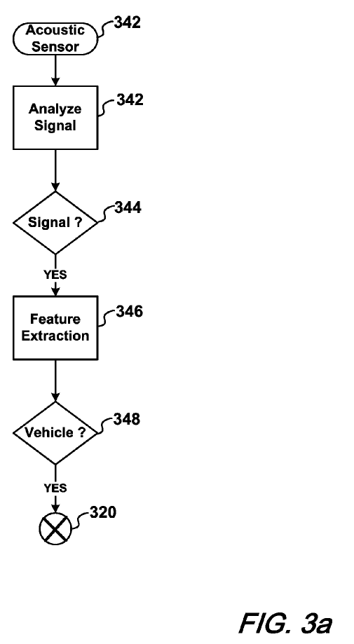

Turning now to FIG. 3, there is shown—in conjunction with FIG. 3a, the complete flowchart, which depicts our inventive fusion methodology for determining the nature of an object being detected by a combination of E-Field, B-Field and/or Acoustic sensors. With simultaneous reference now to FIG. 3 and FIG. 3a, when an object encounters for example, a B-field sensor 302 a signal is produced. Consequently, that B-field sensor signal is analyzed continually to determine whether a signal is present or not 304, 306 which would be indicative of magnetic material. If there is no signal, then there is either no target 310 or a human without metal (magnetic metal) present 314. Conversely, if a B-Field sensor signal is present, there may exist a human object with metal 318, or a vehicle 322 present in the particular surveillance area.

Determining what type of object requires additional data, and fusing that additional data with that acquired from the B-field sensor. Accordingly, the E-Field sensor 322 operates similarly by constantly analyzing its signal 334 and determining whether a B-Field signal is present 336. If not, and there was also no signal from the B-Field sensor, the combination of these conditions 308 is determined to be such that no target is detected within the surveillance area 310.

If, on the other hand, an E-field signal is detected, certain features of that detected signal are extracted 338 and from the extracted features a determination is made whether any arm/leg motion is detected 340. If arm/leg motion is detected and no signal is detected at the B-Field sensor, then a human without metal is being detected 314. If, on the other hand, arm/leg motion is detected from E-Field measurements 340 and B-Field sensors are producing signals, then a human with metal is being sensed 318.

Finally, and according to the present invention, it is noted that an acoustic sensor 342 is operating simultaneously with the E-Field and B-Field sensors. It too, is constantly analyzing any signals present 342 and if a signal is present 344, then particular features of the signal are extracted according to known methods 346 to determine whether the detected acoustic signature(s) are consistent with those of a vehicle 348. If such a determination is made—that is a vehicle acoustic signature is detected—and the E-Field sensor does not detect Arm/Leg motion 340, and the B-Field Sensor does detect a metallic object 306, then with a high level of confidence the detected object is a vehicle and such a determination is made 322.

As should now be apparent by those skilled in the art, the novel combination of B-Field, E-Field and Acoustic sensors coupled with our inventive data fusion methodology allows one to determine with a high degree of confidence whether a detected object is a person, a person with a metal object—such as a firearm—or a vehicle. Advantageously, our method and apparatus allows one to determine whether a detected object represents a threat or not—and therefore permitting an appropriate response to its presence.

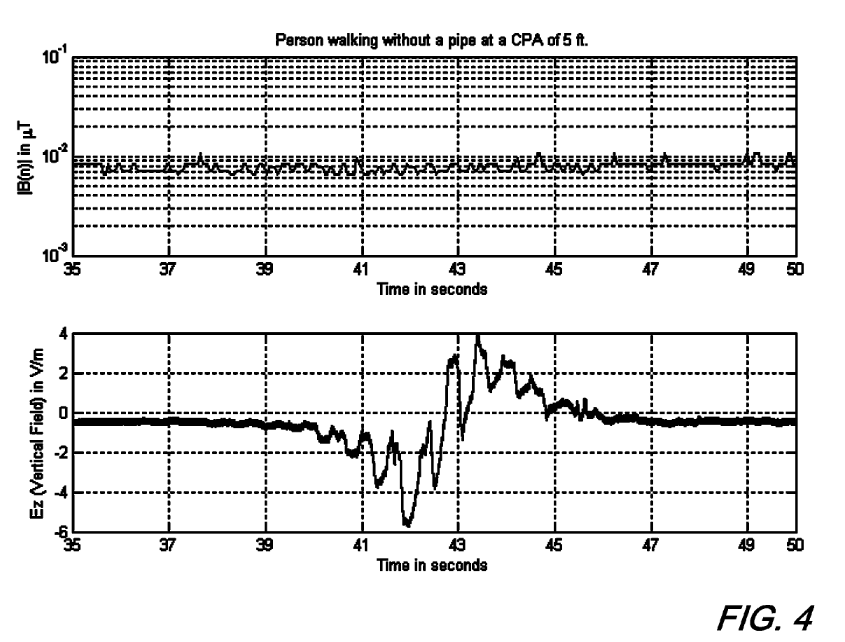

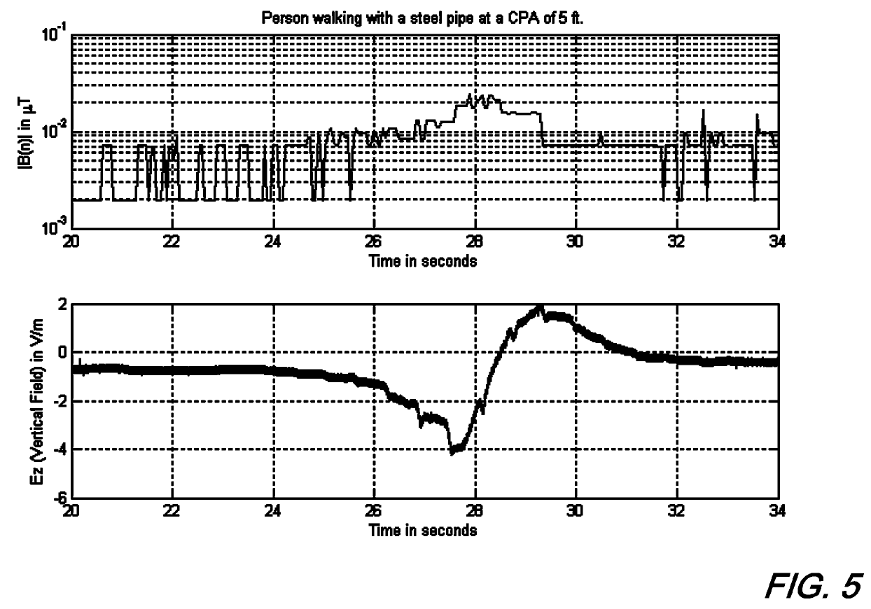

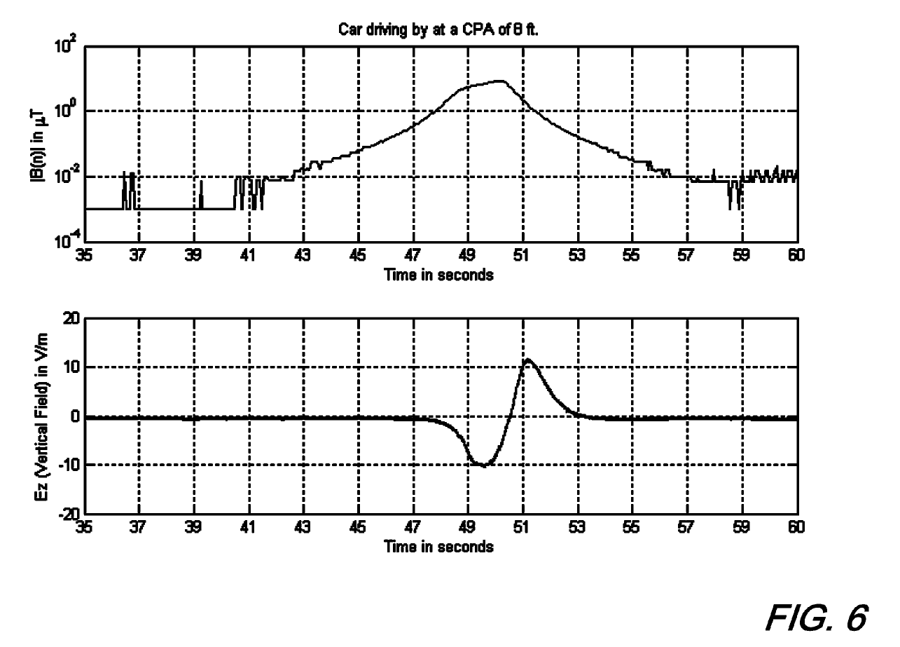

In evaluating our inventive methodologies and systems, we measured a number of E-Field perturbations for a person without a pipe, a person with a metallic pipe and a vehicle. The graphs depicting those measured results are shown in FIG. 4, FIG. 5, and FIG. 6, respectively.

It should also be noted at this time that given the nature of our inventive data fusion methodology, the actual B-Field, E-Field, and Acoustic measurements need not be made simultaneously. Instead, all that is required is for the appropriate measurements be associated with a particular object.

For example, if an object were detected at a point in time by a particular B-Field sensor, and that object moved within the surveillance area such that it was subsequently detected by an E-Field sensor and/or Acoustic sensor, our inventive fusion system would be able to track that objects movement within the sensory/surveillance area, and associate the objects earlier acquired B-Field characteristics with the now acquired E-Field and/or Acoustic characteristics. Consequently, an accurate determination of that object would still result.

So far, our discussions have been concerned with the fusion of data from a number of disparate sensor systems spread throughout a sensor area the data from which are fused by remote systems. Those skilled in the art will quickly recognize that an individual sensor system, may advantageously include multiple, individual disparate sensors such that the data fusion, and object determination may be made remotely in close proximity to the sensor operation.

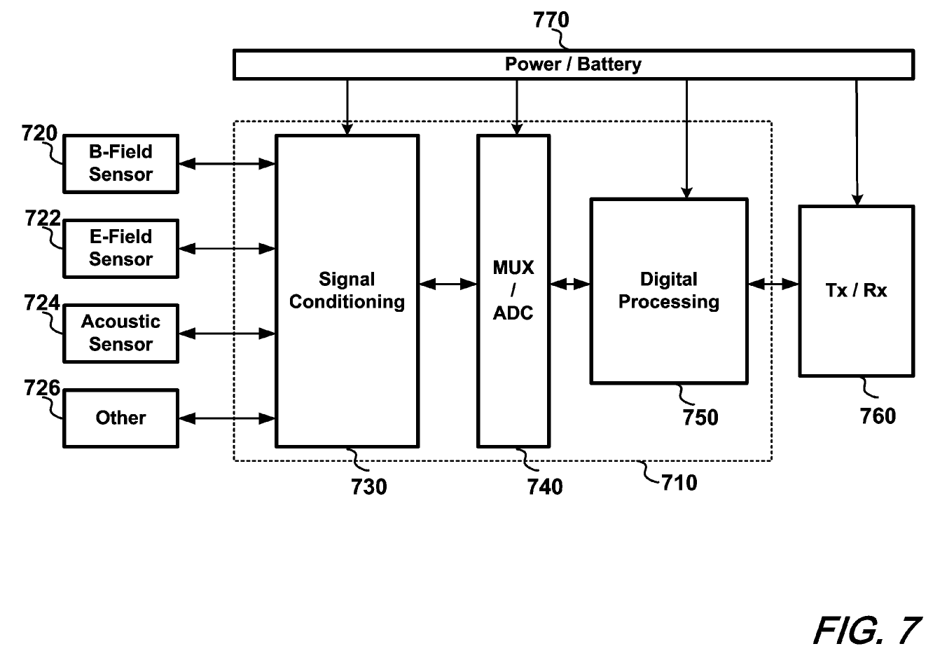

With reference now to FIG. 7, there is shown a block diagram depicting a representative, integrated sensor system including processing. More specifically, the integrated sensor system 710 may include—according to the present invention—a B-Field sensor 720, an E-Field sensor 722 and an acoustic sensor 724 each providing sensory input to the integrated system 710.

As shown in FIG. 7, the integrated system may include analog or other signal conditioning 730, multiplexers and/or Analog/Digital converter 740, for converting the generally analog sensor data to digital data where it may be subsequently processed and or analyzed by digital processing subsystem 750 and subsequently transmitted 760 to remote systems. Power to the remote systems may be locally provided by batteries 770.

Given the state of present day sensors, and analog as well as digital systems, it is of course possible to construct a sensor system such as that in FIG. 7, that collects the data from the disparate sensors and locally fuses that data into actionable information through the effect of local digital processing system. Such determinations may be further relayed upstream for further processing and/or monitoring/and/or action through transmitting/receiver systems.

Of course, it will be understood by those skilled in the art that the foregoing is merely illustrative of the principles of this invention, and that various modifications can be made by those skilled in the art without departing from the scope and spirit of the invention. In particular, different sensor(s) and or master processor system combinations are envisioned. Additionally, alternative conditioning/extraction/compression schemes will be developed, in addition to those already known and well understood. Accordingly, our invention is to be limited only by the scope of the claims attached hereto.

What is claimed is:

1. In a surveillance system comprising a number of individual sensors, wherein the number of individual sensors includes at least one E-Field sensor and at least one B-Field sensor, an object determination method comprising the steps of:
determining, from data acquired by the E-Field sensor(s) whether an object sensed by the sensor(s) is a human being;
determining, from data acquired by the B-Field sensor(s) whether the object sensed by the sensor(s) has metallic characteristic(s); and
determining, from the above determinations, the nature of the object(s) wherein the object is one selected from the group consisting of: 1) No Object; 2) A Human Being Without Metal; 3) A Human Being With Metal; or 4) A Vehicle.

2. The method according to claim 1 wherein the number of individual sensors includes at least one Acoustic sensor, said method further comprising the step(s) of:
determining, from data acquired by the Acoustic sensor(s), whether the object sensed by the sensor(s) is a vehicle.

3. The method according to claim 2, further comprising the steps of:
determining, from data acquired by the Acoustic sensor(s), whether the vehicle sensed is an armored vehicle or not.

4. The method according to claim 1 wherein the B-Field determining step further comprises the steps of:
acquiring, by the B-Field sensor, B-Field specific data;
analyzing, the acquired B-Field specific data; and
determining, from the analyzed B-Field specific data, whether a B-Field signal sufficient for metallic determination is present.

5. The method according to claim 1, wherein the E-Field determining step further comprises the steps of:
acquiring, by the E-Field sensor, E-Field specific data;
analyzing, the acquired E-Field specific data;
determining, from the analyzed E-Field specific data, whether an E-Field signal sufficient for human determination is present.

6. The method according to claim 5 further comprising the step(s) of:
extracting, particular features from the analyzed E-Field specific data; and
determining, from the extracted features whether the motion of appendages (arms/legs) is present in the object.

7. The method according to claim 2 wherein said Acoustic data determining step further comprises the steps of:
acquiring, by the Acoustic sensor, Acoustic specific data;
analyzing, the acquired Acoustic specific data; and
determining, from the analyzed Acoustic specific data, whether an Acoustic signal sufficient for determination is present.

8. The method according to claim 7 further comprising the step(s) of:
extracting, particular features from the analyzed Acoustic specific data; and
determining, from the extracted features whether the object is a vehicle.
